(19) United States
(12) Patent Application Publication
(10) Pub. No.: US 2012/0329502 A1
(43) Pub. Date: Dec. 27, 2012

(54) Feedback Signaling

(76) Inventors: Frank Frederiksen, Klarup (DK); Istvan Zsolt Kovacs, Aalborg (DK); Hung Ngyen, Aalborg Ost (DK)

(21) Appl. No.: 13/522,071

(22) PCT Filed: Jan. 15, 2010
(86) PCT No.: PCT/EP2010/050433

§ 371 Date: Sep. 10, 2012

(51) Int. Cl. H04W 72/04

(52) U.S. Cl. 455/509

(57) ABSTRACT

There is provided an improved solution for generating and compressing uplink channel feedback information in a communication system. The solution includes determining, at a user terminal, information related to a condition of at least one channel between the user terminal and at least one communication point of a cooperative multi-point transmission network, and generating feedback information including, for each reporting sub-band, a channel condition of a predetermined resource block and at least one differential channel condition of at least one other resource block within the same reporting sub-band. The generated feedback information may be communicated to a control node of the co-operative multipoint communication network.

### FIELD

The invention relates generally to mobile communication networks. More particularly, the invention relates to uplink feedback signaling for downlink cooperative multi-cell transmission schemes.

### BACKGROUND

In radio communication networks, such as the Long Term Evolution (LTE) or the LTE-Advanced (LTE-A) of the 3^{rd} Generation Partnership Project (3GPP), the network requires feedback related to channel conditions between a transmitter (e.g. a common base stations (Node B, NB)) and a receiver (e.g. a user terminal (UT)). On the basis of the channel conditions, the eNB may decide for example which modulation and coding to apply in communication between the eNB and the UT. Without compromising the reliability of the feedback, it is advantageous to keep the overhead produced due to the feedback as low as possible while still maintaining good performance. Therefore, an improved solution is needed for providing feedback to the eNB.

### BRIEF DESCRIPTION OF THE INVENTION

Embodiments of the invention aim to improve the uplink feedback signaling for downlink cooperative multi-cell transmission schemes.

According to an aspect of the invention, there are provided methods as specified in claims 1 and 8.

According to an aspect of the invention, there are provided apparatuses as specified in claims 11 and 18.

According to an aspect of the invention, there are provided computer program products as specified in claims 21 and 22.

Embodiments of the invention are defined in the dependent claims.

### LIST OF DRAWINGS

In the following, the invention will be described in greater detail with reference to the embodiments and the accompanying drawings, in which

FIG. 1 presents a communication network according to an embodiment;

FIG. 2 shows a communication network according to an embodiment;

FIG. 3 shows a structure of channel state feedback information according to an embodiment;

FIG. 4 illustrates a procedure between a user terminal and a base station according to an embodiment; and

FIG. 5 illustrates an apparatus capable of generating the feedback information according to an embodiment;

FIG. 6 illustrates an apparatus capable of processing the feedback information according to an embodiment;

FIG. 7 presents a method of generating the feedback information according to an embodiment; and

FIG. 8 shows a method of applying the feedback according to an embodiment.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments.

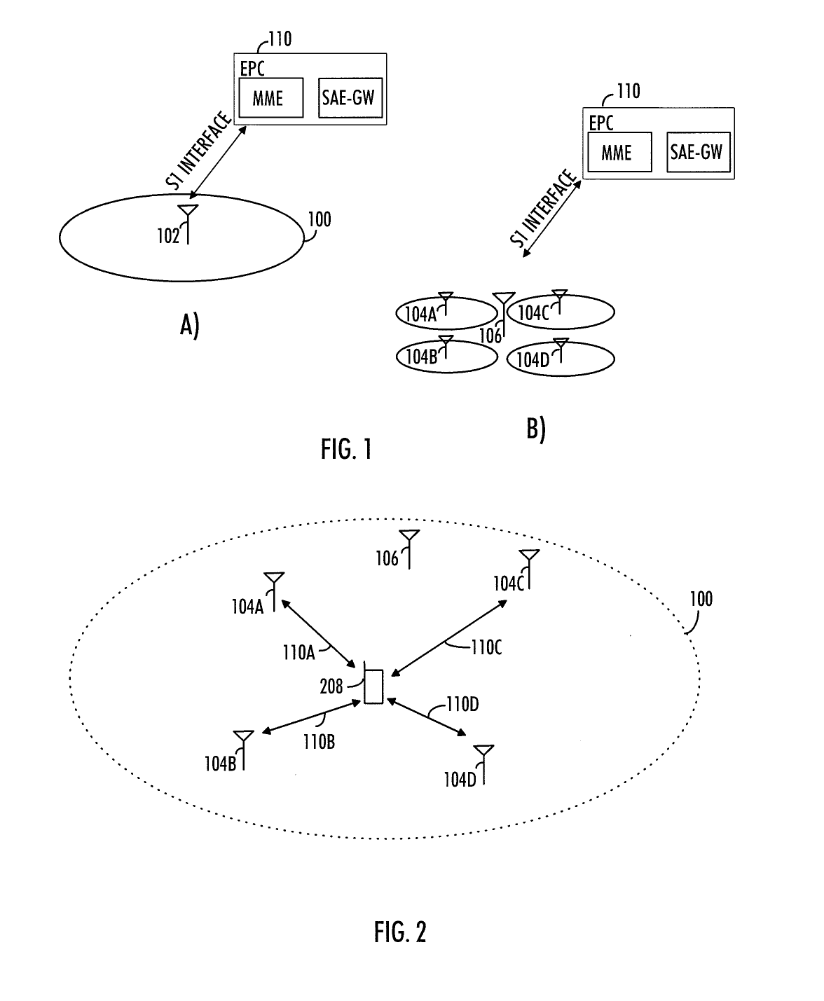

FIG. 1 shows a communication network, according to an embodiment. The communication network may comprise a public base station 102. The public base station 102 may provide radio coverage to a cell 100, control radio resource allocation, perform data and control signaling, etc. The cell 100 may be a macrocell, a microcell, or any other type of cell where radio coverage is present. Further, the cell 100 may be of any size or form, depending on the antenna system utilized.

The public base station 102 may be configured to provide communication services according to at least one of the following communication protocols: Worldwide Interoperability for Microwave Access (WiMAX), Universal Mobile Telecommunication System (UMTS) based on basic wideband-code division multiple access (W-CDMA), high-speed packet access (HSPA), longterm evolution (LTE), and/or LTE advanced (LTE-A). The public base station 102 may additionally provide the second generation cellular services based on GSM (Global System for Mobile communications) and/or GPRS (General Packet Radio Service). The present invention is not, however, limited to these protocols.

The public base station may be used by multiple network operators in order to provide radio coverage from multiple operators to the cell 100. The public base station 102 may also be called an open access base station or a common base station. The public base station 102 may be seen as one communication point of the network. The public base station 102 may also be called a wide area (WA) base station due to its broad coverage area. The wide area base station 102 may be node B, evolved node B (eNB) as in LTE-A, a radio network controller (RNC), or any other apparatus capable of controlling radio communication and managing radio resources within the cell 100. The public base station 102 may also have an effect on mobility management by controlling and analyzing radio signal level measurements performed by a user terminal, carrying out its own measurements and performing handover based on the measurements.

For the sake of simplicity of the description, let us assume that the public base station is an eNB. The development of E-UTRAN is concentrated on the eNB 102. All radio functionality is terminated here so that the eNB 102 is the terminating point for all radio related protocols. The E-UTRAN may be configured such that orthogonal frequency division multiple access (OFDMA) is applied in downlink transmission, whereas single carrier frequency division multiple access (SC-FDMA) may be applied in uplink, for example. In the case of multiple eNBs in the communication network, the eNBs may be connected to each other with an X2 interface as specified in the LTE.

The eNB 102 may be further connected via an S1 interface to an evolved packet core (EPC) 110, more specifically to a mobility management entity (MME) and to a system architecture evolution gateway (SAE-GW). The MME is a control plane for controlling functions of non-access stratum signaling, roaming, authentication, tracking area list management, etc., whereas the SAE-GW handles user plane functions including packet routing and forwarding, E-UTRAN idle mode packet buffering, etc. The user plane bypasses the MME plane directly to the SAE-GW. The SAE-GW may comprise two separate gateways: a serving gateway (S-GW) and a packet data network gateway (P-GW). The MME controls the tunneling between the eNB and the S-GW, which serves as a local anchor point for the mobility between different eNBs, for example. The S-GW may relay the data between the eNB and the P-GW, or buffer data packets if needed so as to release them after appropriate tunneling has been established to a corresponding eNB. Further, the MMEs and the SAE-GWs may be pooled so that a set of MMEs and SAE-GWs may be assigned to serve a set of eNBs. This means that an eNB may be connected to multiple MMEs and SAE-GWs, although each user terminal is served by one MME and/or S-GW at a time.

So called co-operative multipoint transmission (CoMP) may be applied to further enhance the efficiency of the communication network. Communication points/nodes (CP) 104A to 104D in the CoMP schemes can be traditional eNBs, equipped with one or more antennas and having full BS capabilities. The CPs 104A to 104D of the CoMP co-operate with each other via a backhaul link such as a transport medium or an X2 interface as in the specifications of the LTE.

In addition, there may be an additional entity which performs the link adaptation and packet scheduling commonly for all these CPs 104A to 104D and for the served UTs. The additional entity may be called a control node 106 also referred to as an anchor point/node or a control eNB. The control eNB 106 may be located separately from the CPs 104A to 104D, as shown in FIG. 1B, or integrated within one of the CPs 104A to 104D. The control eNB 106 may communicate via the S1 interface with the EPC 110.

The coverage area of the multi-CP system need not be the same as for the single-CP in FIG. 1A. Actually, each of the CPs 104A to 104D in FIG. 1B may have the same coverage area as in FIG. 1A. The control eNB 106 may also have a coverage area similar to that of the other CPs 104A to 104D.

In order to enable interference-free communication between user terminals and the CPs 104A to 104D, the control eNB or each of the CPs 104A to 104D need channel knowledge of each of the links between the user terminals and the communication points. Without such information, the interference may become a significant bottleneck for the efficiency of a mobile radio communication employing the CoMP. However, the exchange of full channel information may require intensive backhaul usage in the network. Therefore an improved solution for the channel state information feedback procedure from the served terminals is needed.

FIG. 2 shows another network employing the CoMP transmission, according to an embodiment. The figure shows at least one user terminal 208. The UT 208 may be a palm computer, user equipment or any other apparatus capable of operating in a mobile communication network. Under the CoMP transmission scheme the UT 208 can receive signals from several geographically distributed CPs 104A to 104D (cells). One option for the CoMP is joint processing (JP) transmission, where the UT 208 receives downlink data channel signals on the user plane from the geographically distributed CPs 104A to 104D simultaneously. However, the UT 208 could be effectively connected on the control plane only to the CP 104A and perform uplink and downlink control channel communication only with the serving CP 104A, for example. This is because, in practice, the propagation loss between a CP and a UT limits the situation such that only certain CPs can communicate with a certain UT. Each CP 104A to 104D generates a cell of its own to be applied in communication purposes, as shown in FIG. 1B. In other words, the CPs 104A to 104D represent separate eNBs controlled by the control node 106. As said above, one of the CPs 104A to 104D may serve as the control point 106. When this is the case, there is no need for a separate control point. However, for the sake of clarity, let us assume that the control point (such as a control eNB) 106 is separated from the CPs (eNBs) 104A to 104D.

In FIG. 2, it is assumed that the UT 208 receives simultaneous downlink transmission from each of the CPs 104A to 104D via wireless communication links 110A to 110D, respectively. The communication links 110A to 110D may apply the orthogonal frequency division multiple access (OFDMA) in the downlink (forward link) and the single carrier frequency division multiple access (SC-FDMA) in the uplink (reverse link), as specified in the LTE. The operating principles are general knowledge to a person skilled in the art and are therefore not disclosed here.

According to an embodiment, the UT 208 may determine information related to the condition of at least one downlink channel 110A to 110D between the user terminal 208 and at least one communication point 104A to 104D of a co-operative multi-point transmission network.

The condition of the channel may be expressed in many ways. For example, the channel condition may be given by means of channel state information (CSI), a precoding matrix index (PMI), a rank indicator (RI), or the channel quality indicator (CQI). The PMI indicates the index of a predefined codebook which comprises information related to the precoding weights that may be used in transmission of data in a multiple antenna system. In order to reduce the overhead signaling, the PMI is used instead of the actual weights. The RI, on the other hand, indicates the preferred rank that is to be used in the communication, i.e. the preferred number of streams to be transmitted. The maximum rank may be obtained with a formula R=min (N_{RX}, N_{TX}), where N_{RX} and N_{TX} represent the number of antenna elements in the receiver and transmitter, respectively. For example, in a 2×4 MIMO system the maximum rank is two.

The CQI can be a value (or values) representing a measure of channel quality for a given channel. Typically, a high value CQI is indicative of a channel with high quality and vice versa. A CQI for a channel can be computed by making use of performance metric, such as a signal-to-noise ratio (SNR), signal-to-interference plus noise ratio (SINR). The CQI can be derived from measurements performed at the UT 208 on a cell-specific reference signal (RS) obtained via the downlink from the eNB. Furthermore, an alternative to the CQI report is to express an interference floor at the UT 208 with respect to the reporting sub-band or with respect to a wider bandwidth. According to an embodiment, the CQI may have a format including both a single-cell and a multi-cell CoMP, if needed. That is, the CQI may represent a single CQI value for a single cell transmission, or a single CQI value for a multi-cell CoMP transmission.

Further, channel state information (CSI) may be provided as the channel condition by the UT 208 as feedback information in the uplink. For example, the CSI may comprise the amplitude and the phase for each Tx-Rx antenna pair on each terminal-to-CP radio link 110A to 110D. The CSI can be derived from measurements performed at the UT 208 on a cell-specific CSI reference signal (CSI-RS) obtained via the downlink from the CoMP eNBs 104A to 104D. Thus, the channel state information is information about the current value of a matrix H representing the downlink communication channel towards one of the CPs 110A to 110D. The H matrix may be applied in the signal model as R=H·S+N, wherein R is the received signal, S is the transmitted signal and N denotes the additive noise of the channel. These parameters are time varying. Especially H is fast varying in wireless channels. For this reason the eNB 106 ideally needs to know the channel matrix H (or an estimate thereof) for all served terminals operating in CoMP mode and for all their serving CPs at any given time in order to optimize the overall downlink system performance. The obtained estimates at this terminal or these terminals may be provided to the control eNB 106 via the CPs 104A to 104D. Although this type of explicit feedback is relatively accurate, it comes with high UL signaling overhead.

On the other hand, the CSI may be of implicit type in which the UT 208 provides PMI to the control node (eNB) 106 with respect to each communication link 110A to 110D. The feedback may then be used for the determination of CoMP joint processing transmission modes, for example. The PMI information may be an index in a large codebook. The PMI information may also be defined as quantized amplitude/phase of the channel eigenbeam vector, for example.

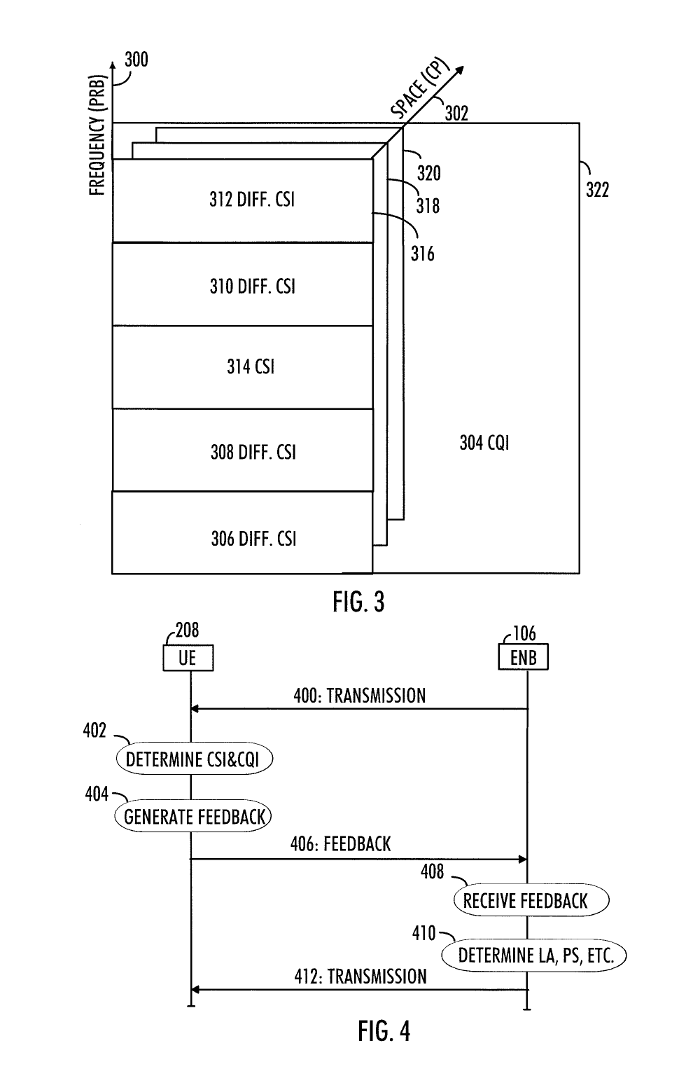

Regardless of whether the feedback data is full channel state information, a channel eigenbeam vector or an index in a codebook, it is beneficial to apply some form of CQI/CSI feedback compression (reduction) scheme. The CQI/CSI feedback information may be transmitted to the serving CP in every reporting sub-band, where the reporting sub-band is defined in frequency. Let us take a look at this more closely with reference to FIGS. 2 and 3.

After the user terminal 208 has determined the condition of the at least one channel 110A to 110D, the user terminal 208 may generate feedback information comprising, for each reporting sub-band, 322 a channel condition of a predetermined resource block 314 and at least one differential channel condition of at least one other resource block 306 to 312 within the same reporting sub-band 322. Thus, instead of generating full feedback information for every resource block 306 to 314, only a difference compared to a certain other resource block is communicated regarding the resource blocks 306 to 312. This is beneficial in reducing the signaling overhead required for appropriate feedback.

The full channel condition for the predetermined resource block 314 may comprise information which alone describes a channel condition of the predetermined resource block 314, whereas the differential channel condition describes the condition of a channel when read together with at least one other piece of reference information, e.g. related to the resource block 314.

In FIG. 3, the reporting sub-band 322 comprises at least two resource blocks 306 to 314. In an embodiment, the number of resource blocks 306 to 314 within a reporting sub-band is five. The resource blocks 306 to 314 have a dimension in a frequency axis 300, that is, the resource block 306 to 314 may comprise a certain number of subcarriers, for example. In an embodiment and according to the specifications of the LTE, the resource blocks 306 to 314 may be called physical resource blocks (PRB) which have a dimension also in time domain. That is, a PRB in the LTE comprises 12 subcarriers in the frequency domain and six or seven OFDM symbols in the time domain.

The resource blocks may be defined with variable sizes. The size may be defined in frequency, for example. For instance, a predetermined resource block 316 may be larger/smaller than the other resource blocks 306 to 312. The resource blocks 306 to 312 may also vary in size. The size of the resource block 306 to 314 may be pre-configured or provided as signaled information to the user terminals of the CoMP network.

The generated feedback information may then be communicated to the control node 106 of the co-operative multipoint transmission network. The communication may be direct communication between the user terminal 208 transmitting the feedback report and the control node 106, or the communication may be indirect via at least one of the communication points 104A to 104D who are connected to the control eNB 106. In the latter case, the user terminal 208 may transmit all the feedback reports related to the at least one of the communication links 110A to 110D via one communication point which may be the serving CP, for example. Alternatively the user terminal 208 may transmit the feedback reports via each of the corresponding CPs 104A to 104D whose respective communication link 110A to 110D has been analyzed.

The differential encoding of the feedback reports allows for certain amount of compression. The differential channel condition of at least one other resource block 306 to 312 represents the difference in the channel condition compared to one of the following: the channel condition of the predetermined resource block 314, or the channel condition of the neighboring resource block 306 to 312. In the former case, the differential channel condition of the resource block 306 may represent the difference between the determined channel condition values of the resource block 306 and the predetermined resource block 314 (for which the full channel condition has been derived), for example. As another example, according to the latter case, the differential channel condition of the resource block 306 may represent the difference between the determined channel condition values of the resource block 306 and the resource block 308. Therefore, by knowing the channel condition of the predetermined resource block 314, the channel conditions of the following resource block 306 to 312 may be obtained by accumulating the differences of the received differential channel condition reports. Further, it is possible that the direct measured CSI for more than one predetermined resource block 316 is communicated. Therefore, the channel condition of the neighboring resource block may be the direct measured channel condition of the neighboring resource block, or it may be relative to the signaled version of the CSI of the neighboring resource block.

As mentioned earlier, the channel condition may be expressed in many ways, including the CQI, the PMI, the RI, and the CSI. The channel condition reported with the differential encoding may, thus, be any of the above or in principle any parameter indicating the condition of a channel.

According to an embodiment, the CSI is determined as the information related to the condition of a channel, wherein the CSI represents at least one of the following: an amplitude of the channel between the user terminal 208 and the corresponding communication point 104A to 104D, a phase of the channel between the user terminal 208 and the corresponding communication point 104A to 104D, and a precoding codebook index. Therefore, the CSI is communicated to the control eNB 106 by means of differential channel condition reports as described above with reference to FIG. 3. More precisely, the CSI may represent the explicit channel H (per CoMP communication point 104A to 104D), the joint channel eigenbeam vector (over the CoMP communication points 104A to 104D), or a precoding vector/matrix index of a codebook (PMI).

The full CSI may be represented, for example, with a 5-bit quantization: two bits for the amplitude and three bits for the phase. That is, in order to further reduce the signaling overhead, quantizing the information related to the condition of a channel prior to communicating the information to the control node 106 may take place. Whereas the full CSI may be expressed with five bits, the differential channel condition does not need as many bits. According to an embodiment, the differential report of the channel condition after quantization may be given in three bits: one bit for the amplitude of the channel and two bits for the phase of the channel. Therefore, the number of bits needed for reporting the frequency selective channel conditions within the reporting sub-band is significantly reduced with the differential approach.

Even though the condition of the channel from a given terminal is transmitted to at least one of the communication points 104A to 104D, the control point 106 being in control of the CPs 104A to 104D may collect the information related to the communication links 110A to 110D. When there are many user terminals in the CoMP, the control point 106 may collect information from each of them.

According to an embodiment, channel condition information of a specific resource block 306 to 312 may be omitted from being communicated to the receiver of the feedback information when the channel condition of the predetermined resource block 314 is applicable to the specific resource block 306 to 312. That is, when the channel condition of the specific resource block 306 to 312 is the same or nearly the same as the channel condition in the predetermined resource block 314 (for which the full CSI has been or will be communicated), there is no need to transmit the same information again. The receiver of the feedback communication may be configured to know that when no differential feedback is reported, the full CSI is to be used for the channel condition of the specific resource block 306 to 312.

In order for the receiver of the feedback information to know which resource block 306 to 314 corresponds to the received channel condition, a predefined indexing of the resource blocks 306 to 314 within the reporting sub-band may be applied. The indexing or ordering within the reporting sub-band serves as an indicator so that the control point/node/eNB 106 knows which of the resource blocks 306 to 314 has the reported channel conditions. The indexing may be pre-configured or it may be given to the user terminal 208 by the eNB 106 in the initial setup process of the UT 208 in the cell. Further, the control eNB 106 knows which communication channel 110A to 110D is characterized by such channel conditions by analyzing which communication point 104A to 104D provided the reported channel condition.

The differential reports may follow a bit level encoding similar to the Gray-coding algorithm, or alternatively a mapping algorithm such that the signaling points indicated by the differential reports represent the “closest neighbors”. This is to utilize any frequency correlation between PRBs. This is beneficial in that if there is any error during the feedback process, it can easily be detected/corrected without extra overhead.

As shown in FIG. 3, a single CQI 304 is also communicated in order for the control eNB 106 to be able to perform optimal packet scheduling, for example. By knowing the CSI information, it is possible to calculate a supported transport block size and modulation scheme, for example, which may be reported directly as the CQI. Instead of transmitting the CQI for every PRB 306 to 314, the per-PRB CQI measure may not be required for a close-to-optimal user terminal scheduling. Therefore, a sub-band based CQI is applied. According to an embodiment, for each reporting sub-band, a single channel quality indicator is determined and communication of information related to the CQI is caused to the control node 106, wherein the single CQI represents the joint channel quality for a specific user terminal in the cooperative multi-point transmission network. Therefore the estimated CQI reflects the CQI obtained when the UT receives signal(s) simultaneously transmitted from a plurality of communication points and received coherently at the UT. Thus, there may be only one single CoMP CQI that needs to be reported. The benefit of this is that the CQI is transmitted only once per reporting sub-band which reduces the overhead. In principle, the CSI may also be compressed so that one CSI value corresponds to all CPs, as with the CQI 304.

As the CQI is transmitted only once per reporting sub-band, the method in which the CQI is determined may vary. In one embodiment, the CQI is determined for a specific resource block 306 to 314. Therefore, the CQI describes the CQI of a certain resource block 306 to 314 having certain properties in time and in frequency domains. In another embodiment, the CQI is determined as an average over all the resource blocks 306 to 314 within the reporting sub-band 322. In this case, the CQI denotes/indicates the average expected performance of the channel.

As shown in FIG. 3, the spatial domain 302 comprises at least one communication point (CP). Each of the communication points offering communication links to the user terminal may need a separate feedback reporting 316 to 320. According to an embodiment, the user terminal 208 may transmit separate CSI reports 316 to 320 (the CSI report comprising the full report and the at least one differential report) relating to each of the communication points. For example, assuming that there are four communication points 104A to 104D, the user terminal 208 transmits four feedback reports corresponding to each of the communication links 110A to 110D to the control node 106 of FIG. 2, respectively.

Further compression may be obtained with the principle of antenna virtualization. In general, the feedback CSI can be either a vector or a matrix, depending on the size of the MIMO configuration. In one type of virtualization, the at least two antennas of a communication point 104A to 104D are treated by the user terminal 208 as one single antenna so as to reduce the feedback signaling between the user terminal 208 and the control node 106. In another type of virtualization, the at least two antennas of the user terminal 208 are treated as one single antenna by the control eNB 106 so as to reduce the required feedback signaling related to the channel condition between the user terminal 208 and the communication points 104A to 104D. By treating the number of antennas of the opposite communication end as one, the feedback need not be a matrix, but a vector is sufficient. For example, a vector of channel coefficients representing the amplitude and phase of a channel is sufficient, wherein the dimensions of the vector are [N_{Rx}, 1] or [1, N_{Tx}], instead of [N_{Rx}, N_{Tx}]. This reduces the size of the signaling overhead significantly. In the virtualization process, the N_{Tx}/N_{Rx} needs to be known only at the corresponding side of the communication. Further, the corresponding signal weighting factors may be kept constant over a longer time period.

FIG. 4 shows a signaling flow diagram showing a procedure between the UT 208 and the eNB 106. The communication points 104A to 104D are omitted from the figure for reasons of clarity. The eNB 106 triggers the communication between the UT 208 and the eNB 106 in step 400. The eNB 106 may transmit data together with pilot or reference signals that the UT 208 may apply in determining the CSI and CQI in step 402. After generating the feedback for each communication link in the CoMP network in step 404, the UT 208 may transmit the feedback to the eNB 106 in step 406. The feedback report may be similar to that shown in FIG. 3, for example.

According to an embodiment, the eNB 106, as the control point of the CoMP network, receives in step 408, for each reporting sub-band, information related to the condition of each channel between at least one user terminal 208 and at least one communication point of the CoMP network. The information related each channel may comprise the channel condition of the predetermined resource block within a reporting sub-band and at least one differential channel condition of at least one other resource block within the same reporting sub-band. The channel condition may be CQI, CSI, PMI, RI, etc.

In step 410, the control eNB 106 may perform a link adaptation (LA) mechanism on a shared data channel, which applies a ‘per-need’ basis adaptation of the shared physical resources, as well as utilization of the possible MIMO transmission modes. Therefore, the control point 106 may change the resources allocated to a specific communication link. In order to utilize the current channel conditions as optimally as possible (including link adaptation, packet scheduling, spatial division multiplexing (SDM), etc.), it is essential that the control eNB 106 has an estimate of the channel condition of different users, or the channel condition of one user with respect to different communication points. Therefore, the eNB 106 may determine link adaptation, packet scheduling, SDMA configuration, radio resource allocation, etc. on the basis of the received information related to the channel conditions. In step 412 the eNB 106 performs communication to the user terminal 208 possibly via the at least one communication point according to the determined CoMP configurations.

If differential reports comprise the CSI reports, the eNB 106 may also receive a single CQI value for each reporting sub-band as described above.

According to an embodiment, the eNB 106 may reconfigure the size of the reporting sub-band, wherein the reporting sub-band comprises at least two resource blocks. This is beneficial when the state or properties of the UT 208 change, e.g. when the UT 208 starts moving. This may also be necessary when radio resource re-allocation is needed, the number of UTs increases in the cell, etc.

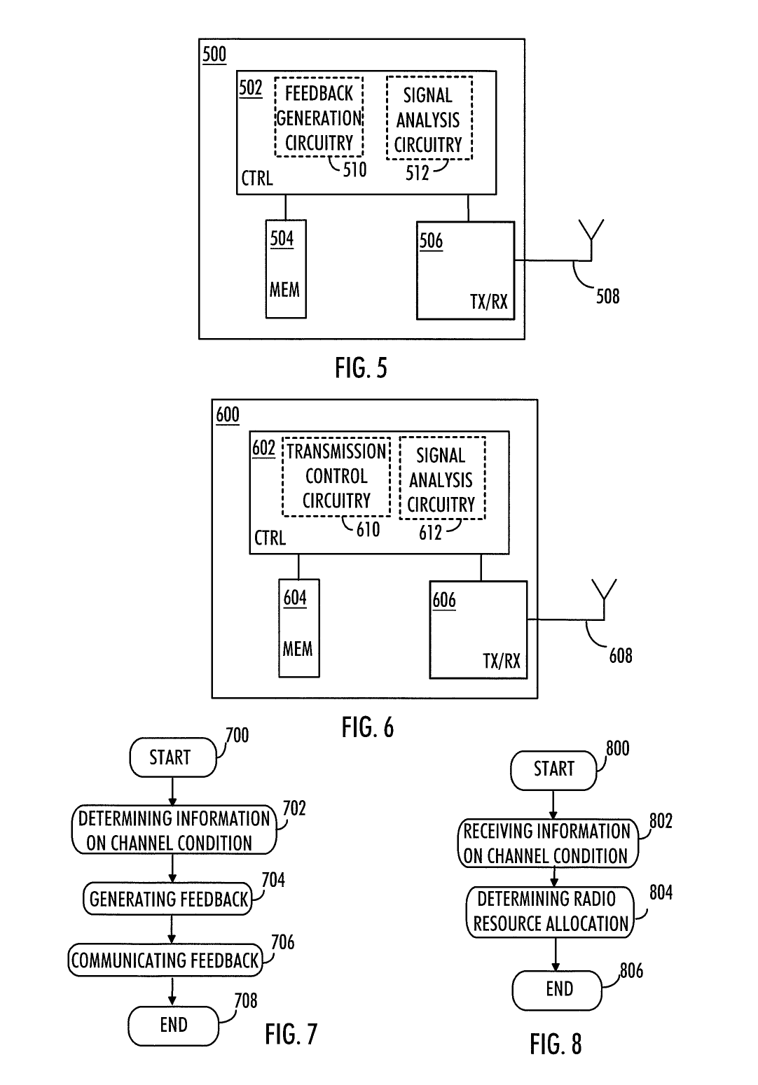

According to an embodiment, the eNB 106 may know that when no differential report is obtained for a specific resource block, the channel condition of the predetermined resource block is applicable to the specific resource block. Very general architectures of apparatuses according to an embodiment of the invention and capable of performing the tasks of a user terminal and a control eNB are shown in FIGS. 5 and 6, respectively. FIGS. 5 and 6 show only the elements and functional entities required for understanding the apparatuses according to embodiments of the invention. Other components have been omitted for reasons of simplicity. The implementation of the elements and functional entities may vary from that shown in FIGS. 5 and 6. The connections shown in FIGS. 5 and 6 are logical connections, and the actual physical connections may be different. The connections can be direct or indirect and there can merely be a functional relationship between components. It is apparent to a person skilled in the art that the apparatuses may also comprise other functions and structures.

An apparatus 500 of FIG. 5 may comprise a processor 502 and may be configured to perform tasks related to the functionalities of the user terminal as described in this document. The processor 502 may be implemented with a separate digital signal processor provided with suitable software embedded on a computer readable medium, or with a separate logic circuit, such as an application specific integrated circuit (ASIC). The processor 502 may comprise an interface, such as computer port, for providing communication capabilities. The processor 502 may be, for example, a dual-core processor or a multiplecore processor.

The apparatus 500 may comprise a memory 504 connected to the processor 502 However, memory may also be integrated into the processor 502 and, thus, no memory 504 may be required. The memory may comprise a computer program code, it may store data for buffering, etc. The apparatus 500 may further comprise a transceiver (TRX) 506. The TRX 506 may further be connected to one or more antennas 508 enabling connection to and from an air interface.

The processor 502 may comprise a signal analysis circuitry 512 for analyzing the received signals. The received signals may comprise the reference or pilot signals that may be used for determining the channel condition parameter for the channel and the resource block from which the signal was received. The processor 502 may further comprise a feedback generation circuitry 510 for generating feedback reports, such as the one described with reference to FIG. 3. The feedback reports may then be communicated to the eNB via the TRX 506 so that the eNB 106 may obtain knowledge of the channel between the apparatus and the eNB 106.

An apparatus 600 of FIG. 6 may comprise a processor 602 and may be configured to perform tasks related to the functionalities of the control eNB as described in this document. The processor 602 may be implemented with a separate digital signal processor provided with suitable software embedded on a computer readable medium, or with a separate logic circuit, such as an application specific integrated circuit (ASIC). The processor 602 may comprise an interface, such as computer port, for providing communication capabilities. The processor 602 may be, for example, a dual-core processor or a multiplecore processor.

The apparatus 600 may comprise a memory 604 connected to the processor 602. However, memory may also be integrated into the processor 602 and, thus, no memory 604 may be required. The memory may comprise a computer program code, it may store data for buffering, etc. The apparatus 600 may further comprise a transceiver (TRX) 606. The TRX 606 may further be connected to one or more antennas 608 enabling connection to and from an air interface.

The processor 602 may comprise a signal analysis circuitry 612 for analyzing the received signals. The received signals may comprise the feedback generated at the user terminal. The signal analysis circuitry 612 may obtain knowledge of the channel condition between the apparatus 600 and the user terminal on the basis of the analyzed feedback. On the basis of the obtained knowledge, the processor 602 and more specifically, a transmission control circuitry 610, may determine radio resource allocation for the radio links of the CoMP environment. As a result, the apparatus 600 may perform link adaptation, packet scheduling, SDMA configuration, etc. As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present.

This definition of ‘circuitry’ applies to all uses of this term in this application. As a further example, as used in this application, the term circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

FIG. 7 presents a method of generating the feedback information according to an embodiment. The method begins in step 700. In step 702 a user terminal determines information related to the condition of at least one channel between the user terminal and at least one communication point of a co-operative multi-point transmission network. In step 704, the user terminal generates feedback information comprising, for each reporting sub-band, a channel condition of a predetermined resource block and at least one differential channel condition of at least one other resource block within the same reporting sub-band. In step 706, the user terminal causes a communication of the feedback information to the control node of the co-operative multi-point transmission network. The method ends in step 708.

FIG. 8 shows a method of applying the feedback according to an embodiment. The method begins in step 800. In step 802, the control point of the CoMP network receives, for each reporting sub-band, information related to the condition of at least one channel between at least one user terminal and at least one communication point of the CoMP network, wherein the information for each channel comprises a channel condition of a predetermined resource block within a reporting sub-band and at least one differential channel condition of at least one other resource block within the same reporting sub-band. In step 804, the eNB determines radio resource allocation of the co-operative multi-point transmission network on the basis of the received information. The method ends in step 806.

The embodiments of the invention offer many advantages. The frequency selective CQI feedback reporting according to an embodiment may facilitate in performing optimal scheduling for a CoMP network. The feedback may comprise the CQI feedback and an additional, explicit or implicit, CSI. The CSI information may also include the inter-cell (inter CP) channel properties. Furthermore, although the discussion and examples have been given for CoMP joint processing transmission schemes, the embodiment can also be used for other CoMP transmission schemes, e.g. coordinated multipoint beamforming and/or coordinated multipoint scheduling.

The proposed embodiments offer improved accuracy, which facilitates the correct scheduling decision and link-adaptation for a given CoMP UT. These parameters in a given transmission time interval per PRB and sub-band depend very much on the accuracy and type of channel information available at the control eNB. For this reason it is important to obtain accurate feedback from the user terminal.

The embodiments provide improved compression of the feedback data, which enables high granularity: the overall number of bits required per sub-band reporting is reduced significantly (by 45% to 50% assuming no TX/RX antenna virtualization, for example). The compression enabling high granularity in the time and frequency domain may be needed for the CSI feedback in order for the control eNB (CoMP processing unit or CoMP scheduler unit) to be able to optimally perform, for example, MU-MIMO packet scheduling, and an SDM based LA scheme, such as zero forcing.

The embodiments allow for a controlled loss due to the time/frequency compression techniques. The embodiments further allow constant and known overhead for UL transmissions per time unit which is needed for efficient UL resource allocation/utilization with timely delivery of the feedback information. Moreover, the embodiments enable robustness against decoding errors because the scheme minimizes the error propagation in the frequency domain if one or more instances of CQI & PMI feedback per sub-band is erroneously received. As a consequence, possible error propagation may be minimized and localized in both the time and frequency domain.

Further, the scheme is independent from and can be easily combined with different time-domain feedback reporting schemes (periodic/aperiodic, best-M, etc.). The scheme may also be combined with different spatial-domain (across CoMP cells) compression schemes and the Tx/Rx antenna virtualization schemes.

The techniques and methods described herein may be implemented by various means. For example, these techniques may be implemented in hardware (one or more devices), firmware (one or more devices), software (one or more modules), or combinations thereof. For a hardware implementation, the apparatus of FIGS. 5 and 6 may be implemented within one or more application-specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case it can be communicatively coupled to the processor via various means, as is known in the art. Additionally, the components of the systems described herein may be rearranged and/or complemented by additional components in order to facilitate achievement of the various aspects, etc., described with regard thereto, and they are not limited to the precise configurations set forth in the given figures, as will be appreciated by one skilled in the art. Thus, according to an embodiment, the apparatus for performing the tasks of FIGS. 1 to 5, and 7 comprises processing means for determining information related to the condition of at least one channel between the apparatus and at least one communication point of a co-operative multi-point transmission network, and processing means for generating feedback information comprising, for each reporting sub-band, a channel condition of a predetermined resource block and at least one differential channel condition of at least one other resource block within the same reporting sub-band. The apparatus may further comprise processing means for causing communication of the feedback information to the control node of the co-operative multi-point transmission network.

According to an embodiment, the apparatus for performing the tasks of FIGS. 1 to 4, 6, and 8 comprises processing means for receiving for each reporting sub-band information related to the condition of at least one channel between at least one user terminal and at least one communication point of the cooperative multi-point transmission network, wherein the information for each channel comprises a channel condition of a predetermined resource block within a reporting sub-band and at least one differential channel condition of at least one other resource block within the same reporting sub-band, and processing means for determining radio resource allocation of the co-operative multi-point transmission network on the basis of the received information.

Embodiments of the invention may be implemented as computer programs in the apparatus of FIG. 5 according to the embodiments of the invention. The computer programs comprise instructions for executing a computer process. The computer program implemented in the apparatus may carry out, but is not limited to, the tasks related to FIGS. 1 to 5, and 7.

Embodiments of the invention may be implemented as computer programs in the apparatus of FIG. 6 according to the embodiments of the invention. The computer programs comprise instructions for executing a computer process. The computer program implemented in the apparatus may carry out, but is not limited to, the tasks related to FIGS. 1 to 4, 6, and 8.

The computer program may be stored on a computer program distribution medium readable by a computer or a processor. The computer program medium may be, for example but not limited to, an electric, magnetic, optical, infrared or semiconductor system, device or transmission medium. The computer program medium may include at least one of the following media: a computer readable medium, a program storage medium, a record medium, a computer readable memory, a random access memory, an erasable programmable read-only memory, a computer readable software distribution package, a computer readable signal, a computer readable telecommunications signal, computer readable printed matter, and a computer readable compressed software package.

Even though the invention has been described above with reference to an example according to the accompanying drawings, it is clear that the invention is not restricted thereto but can be modified in several ways within the scope of the appended claims. Further, it is clear to a person skilled in the art that the described embodiments may, but are not required to, be combined with other embodiments in various ways.

1. A method, comprising:
determining, at a user terminal, information related to a condition of at least one channel between the user terminal and at least one communication point of a cooperative multipoint transmission network;
generating feedback information comprising, for each reporting sub-band, a channel condition of a predetermined resource block and at least one differential channel condition of at least one other resource block within the same reporting sub-band; and
causing communication of the feedback information to a control node of the cooperative multi-point transmission network.

2. The method of claim 1, wherein the differential channel condition of at least one other resource block represents a difference in the channel condition compared to one of the following: the channel condition of the predetermined re-source block, or the channel condition of a neighboring resource block.

3. The method of claim 1, further comprising:
omitting channel condition information related to a specific resource block from being communicated when the channel condition of the predetermined resource block is applicable to the specific resource block.

4. The method of claim 1, further comprising:
applying predefined indexing of the at least two resource blocks within the reporting sub-band such that the receiver of the feedback information knows which resource block corresponds to the received channel condition.

5. The method of claim 1, further comprising:
determining channel state information as information related to the condition of a channel, wherein the channel state information represents at least one of the following:
an amplitude of the channel between the user terminal and the corresponding communication point, a phase of the channel between the user terminal and the corresponding communication point, and a precoding codebook index.

6. The method of claim 1, further comprising:
Determining, for each reporting sub-band, a single channel quality indicator representing joint downlink channel quality for the user terminal in the co-operative multi-point transmission network; and
causing communication related to the indicator to the control node of the co-operative multi-point transmission network.

7. The method of claim 6, further comprising:
determining the channel quality indicator for a predetermined resource block, or as an average over all the resource blocks within the reporting sub-band.

8. A method, comprising:
receiving at a control node of a co-operative multi-point transmission network, for each reporting sub-band, information related to a condition of at least one channel between at least one user terminal and at least one communication point of the co-operative multi-point transmission network, wherein the information for each channel comprises a channel condition of a predetermined resource block within a reporting sub-band and at least one differential channel condition of at least one other resource block within the same reporting sub-band; and
determining radio resource allocation of the co-operative multi-point transmission network on the basis of the received information.

9. The method of claim 8, wherein the differential channel condition of at least one other resource block represents a difference in the channel condition compared to one of the following: the channel condition of the predetermined resource block, or the channel condition of a neighboring re-source block.

10. The method of claim 8, further comprising: Receiving, for each reporting sub-band, a single channel quality indicator representing joint downlink channel quality for a specific user terminal in the cooperative multi-point transmission network.

11. An apparatus, comprising:
at least one processor and at least one memory including a computer program code, wherein the at least one memory and the computer program code are configured to, with the at least one processor, cause the apparatus at least to:
determine information related to a condition of at least one channel between the apparatus and at least one communication point of a co-operative multi-point transmission network; generate feedback information comprising, for each reporting sub-band, a channel condition of a predetermined resource block and at least one differential channel condition of at least one other resource block within the same reporting sub-band; and
perform communication of the feedback information to a control node of the cooperative multi-point transmission network.

12. The apparatus of claim 11, wherein the differential channel condition of at least one other resource block represents a difference in the channel condition compared to one of the following: the channel condition of the predetermined re-source block, or the channel condition of a neighboring resource block.

13. The apparatus of claim 11, wherein the at least one memory and the computer program code are configured to, with the at least one processor, further cause the apparatus to:
omit channel condition information related to a specific resource block from being communicated when the channel condition of the predetermined resource block is applicable to the specific resource block.

14. The apparatus of claim 11, wherein the at least one memory and the computer program code are configured to, with the at least one processor, further cause the apparatus to:
apply predefined indexing of the at least two resource blocks within the reporting sub-band such that a receiver of the feedback information knows which resource block corresponds to a received channel condition.

15. The apparatus of claim 11, wherein the at least one memory and the computer program code are configured to, with the at least one processor, further cause the apparatus to:
determine channel state information as information related to the condition of a channel, wherein the channel state information represents at least one of the following:
an amplitude of the channel between the apparatus and the corresponding communication point, a phase of the channel between the apparatus and the corresponding communication point, and a pre-coding codebook index.

16. The apparatus of claim 11, wherein the at least one memory and the computer program code are configured to, with the at least one processor, further cause the apparatus to:
determine, for each reporting, sub-band a single channel quality indicator representing joint downlink channel quality for the apparatus in the co-operative multi-point transmission network; and
perform communication related to the indicator to the control node of the co-operative multi-point transmission network.

17. The apparatus of claim 16, wherein the at least one memory and the computer program code are configured to, with the at least one processor, further cause the apparatus to:
determine the channel quality indicator for a predetermined resource block, or as an average over all the resource blocks within the reporting sub-band.

18. An apparatus, comprising:
at least one processor and at least one memory including a computer program code, wherein the at least one memory and the computer program code are configured to, with the at least one processor, cause the apparatus at least to:
receive, for each reporting sub-band, information related to a condition of at least one channel between at least one user terminal and at least one communication point of a cooperative multi-point transmission network,
wherein the information for each channel comprises a channel condition of a predetermined resource block within a reporting sub-band and at least one differential channel condition of at least one other resource block within the same reporting sub-band; and
determine radio resource allocation of the co-operative multi-point transmission network on the basis of the received information.

19. The apparatus of claim 18, wherein the differential channel condition of at least one other resource block represents a difference in the channel condition compared to one of the following: the channel condition of the predetermined resource block, or the channel condition of a neighboring resource block.

20. The apparatus of claim 18, wherein the at least one memory and the computer program code are configured to, with the at least one processor, further cause the apparatus to:
Receive, for each reporting sub-band, a single channel quality indicator representing joint downlink channel quality for a specific user terminal in the co-operative multi-point transmission network.

21. A computer program product embodied on a distribution medium readable by a computer and comprising program instructions which, when loaded into an apparatus, execute the method according to claim 1.

22. A computer program product embodied on a distribution medium readable by a computer and comprising program instructions which, when loaded into an apparatus, execute the method according to claim 8.
